(19) United States
(12) Patent Application Publication
(10) Pub. No.: US 2004/0108416 A1
(43) Pub. Date: Jun. 10, 2004

(54) Airborne platform release securement apparatus

(76) Inventor: Stephen Thomas Parkinson, Vale of Glamorgan (GB)

Correspondence Address: NEEDLE & ROSENBERG, P.C., SUITE 1000, 999 PEACHTREE STREET, ATLANTA, GA, 30309-3915, US

(21) Appl. No.: 10/250,611

(22) PCT Filed: Jan. 4, 2002
(86) PCT No.: PCT/GB02/00007

(30) Foreign Application Priority Data
Jan. 4, 2001 (GB) 0100112.2

(51) Int. Cl. B64D 1/12

(52) U.S. Cl. 244/137.4

(57) ABSTRACT

Safety apparatus (352, 356, 358, 350) for a cargo platform (310) for releasable securement in an aircraft fitted with an complementary type securement system having one ore more retractable catches (22) for engaging the cargo platform, wherein the safety apparatus comprising means to ensure the or each catch (22) of the securement system is moved from a deployed to a retracted position prior to extraction of the platform the aircraft.

The present invention relates to apparatus for releasably securing platforms in aircraft. More particularly, the invention relates to apparatus for improving the safety of extracting systems used for delivering cargo loaded onto platforms out of the rear of an aircraft in flight.

Transport aircraft used by the military to drop vital equipment and supplies onto the battlefield use platforms that are stowed within the aircraft in a guidance system. The platforms are pulled out of the rear of the aircraft and subsequently have their descent from the aircraft controlled by a parachute system.

To ensure that the platforms do not move in-flight, a securement system is provided to releasably secure the platform in a desired position on the track within the aircraft. Differing securement systems have been developed for use by the US and UK military and it is hitherto not been possible to use a single platform on both systems. In one embodiment, the present invention seeks to provide a platform that can be used with both the US and UK securement systems.

Additionally, the US system is susceptible to jamming of the securement system during the extraction of the platform. Using the US type platforms such jamming is not catastrophic as the extraction parachute is of relatively small diameter and thereby cannot stall the aircraft due to the increased drag caused by the parachute. However, if UK type platforms with UK type parachute systems are used with US type securement system, the UK type parachutes are of sufficient diameter to stall the aircraft when de-reefed (i.e. fully opened). Therefore, if jamming occurs and parachute release fails, there is a serious risk that the aircraft will stall due to the increased drag induced by the parachutes trailing from the rear of the aircraft. Another embodiment of the present invention seeks to improve the safety of the US system when used in particular with platforms having UK type parachute systems.

A first aspect of the present invention provides safety apparatus for a cargo platform for releasable securement in an aircraft fitted with a complementary type securement system, having one or more retractable catches for engaging the cargo platform, wherein the safety apparatus comprises means to ensure the or each of the securement system is moved from a deployed to a retracted position prior to extraction of the platform from the aircraft. According to an optional feature of the invention, the safety apparatus may comprise a visual indicator to indicate the deployed/retracted state of the securement system. More preferably the visual indicator may be provided at the fore end of the apparatus.

In one class of embodiments, there may further comprise a recess on the platform for engaging the catch is provided with a movable plug which may be connected by a linkage to the visual indicator wherein the plug is depressed inwardly by the presence of the catch in the recess.

According to another optional feature of this aspect of the invention the safety apparatus may comprise a recess on the platform for receiving the catch with a moveable plug connected to the platform and moveable from a retracted position to a deployed position in which the plug protrudes into the recess to prevent the catch of the securement system from engaging in the recess. Preferably a linkage may connect the plug to locking means for locking the plug into a deployed position so as to prevent engagement of the catch by the recess. More preferably a plurality of plugs may be provided and the locking means may be so constructed and arranged to simultaneously prevent deployment of a plurality of catches.

According to a further optional feature of this aspect of the present invention the safety means may comprise a mechanism to ensure that a second catch of the securement system aft of the platform is retracted to allow the platform to be released. Preferably, the mechanism may comprise a locking pin fitted to the second catch.

In some embodiments, the securement system may have catches arranged so as to normally engage in corresponding recesses and wherein the recesses may be omitted thereby preventing such engagement, the platform being provided with other means for releasable securement. Preferably the other means may comprise a stop that may be deployed to engage the platform. More preferably the stop may engage the fore or aft end of the platform.

The second aspect of the present invention provides a cargo platform comprising safety apparatus capable of releasable securement to aircraft having both the -4a or Skydel securement systems. Preferably the platform may have an outer support with one or more recesses for securement by the -4a system and one or more spigots for securement by the Skydel system. More preferably the platform may be converted from a Skydel only type platform by securing a longitudinal extension piece thereto incorporating the outer support having one or more recesses and one or more spigots.

The third aspect of the present invention provides a method of releasing a platform, the platform being releasably secured on a guidance system in an aircraft using an interference type securement system comprising a catch and a recess, formed in the platform to receive the catch, the method comprising the steps of:

i) retracting the catch; and

ii) employing safety apparatus described above to ensure that the catch is retracted.

Preferably the safety apparatus may indicate the deployed/retracted state of the catch to a user.

According to an optional feature of the third aspect of the present invention the second catch may be provided aft of the platform and there may comprise a further step of preventing the inadvertent deployment of the second catch. Preferably the inadvertent deployment of the second catch may be prevented by pinning the second male portion in a retracted position.

Exemplary embodiments will now be described, by way of example only, with reference to the accompanying drawings in which:

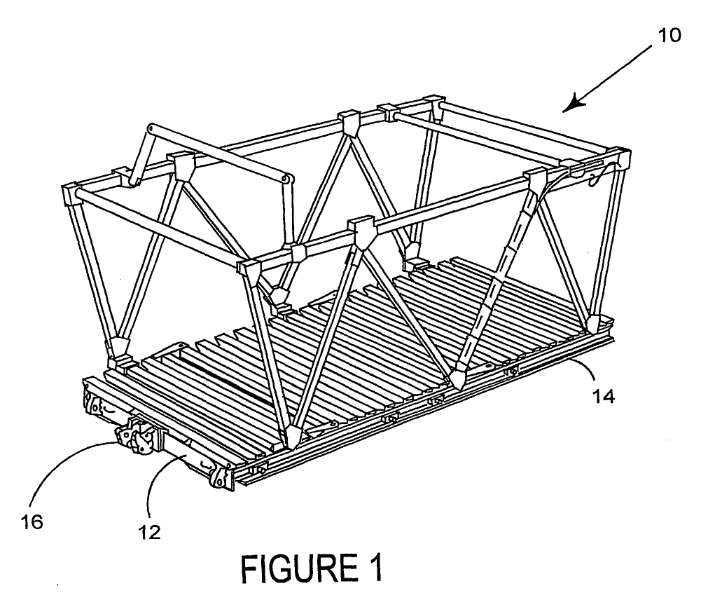

FIG. 1 is a perspective view of a prior art platform;

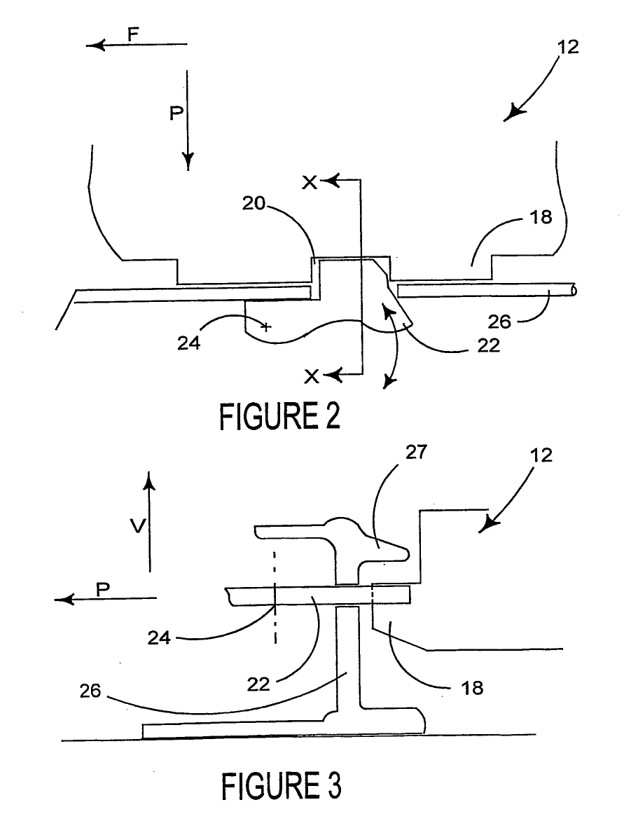

FIG. 2 is a plan view of the prior art US securement system;

FIG. 3 is a cross sectional view through FIG. 2 on the line X-X;

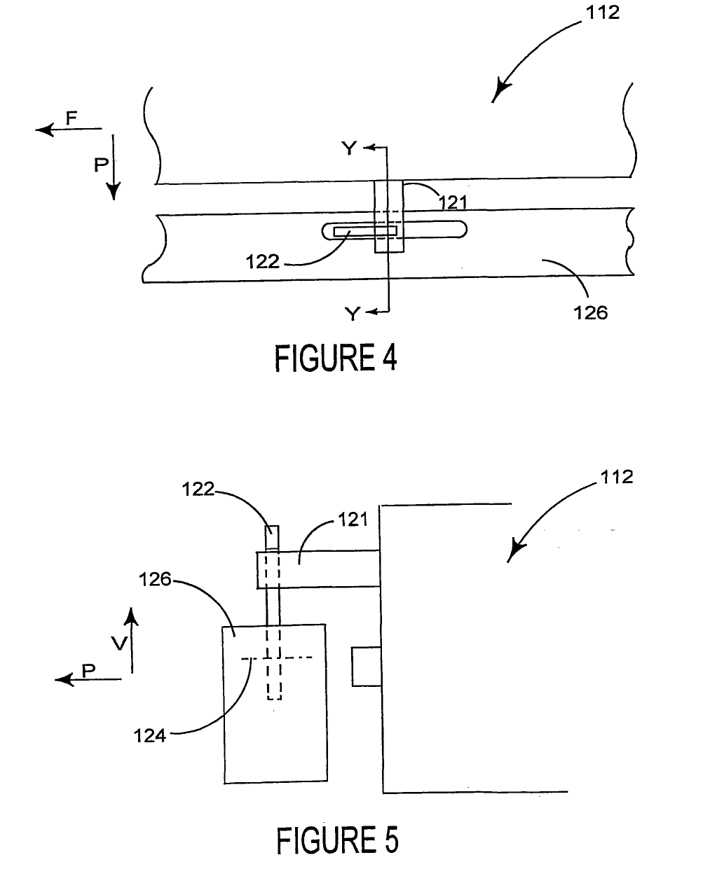

FIG. 4 is a plan view of the prior art UK securement system;

FIG. 5 is a cross sectional view through the apparatus of FIG. 4 along the line Y-Y;

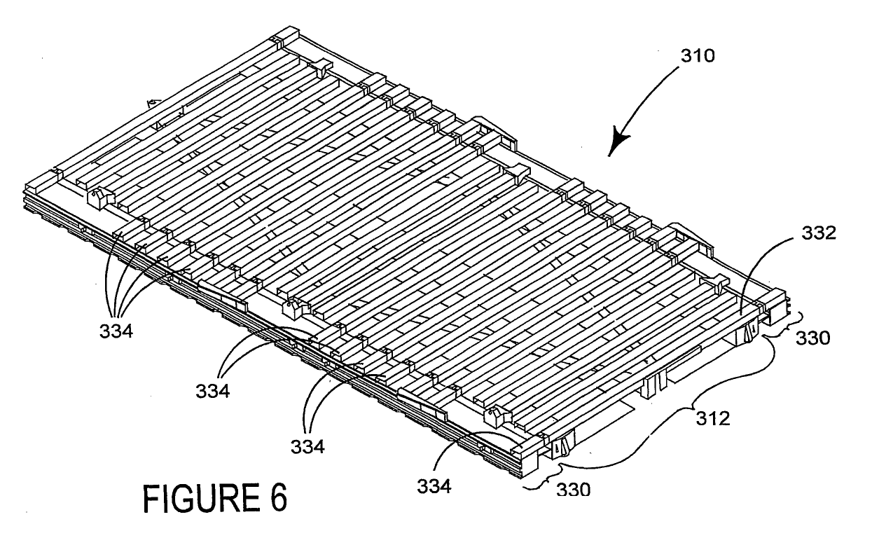

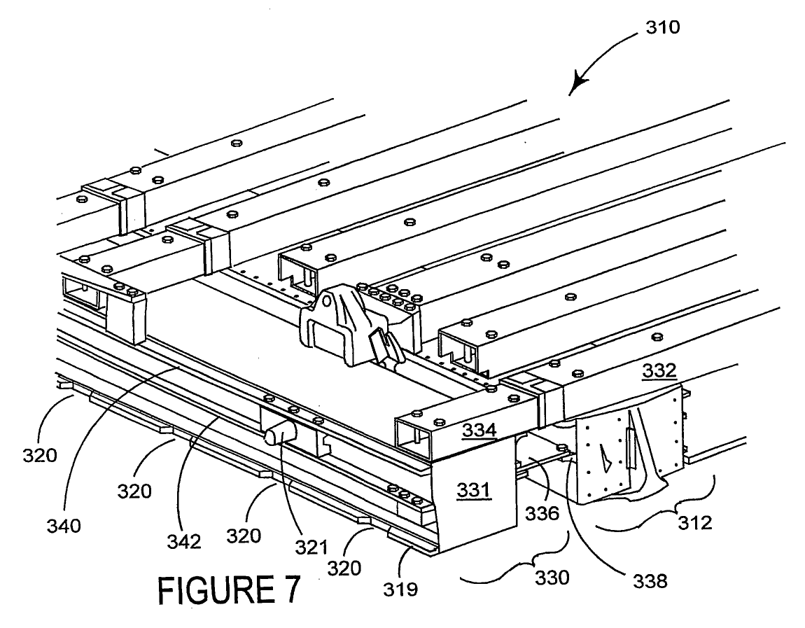

FIG. 6 is a perspective view of a platform according to one embodiment of the present invention;

FIG. 7 is a perspective view of a corner of the platform of FIG. 6;

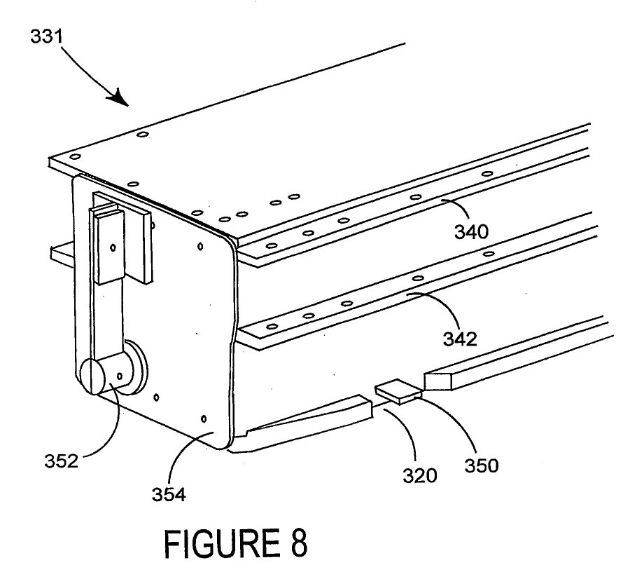

FIG. 8 is a perspective view of a portion of a platform according to another embodiment of the invention; and

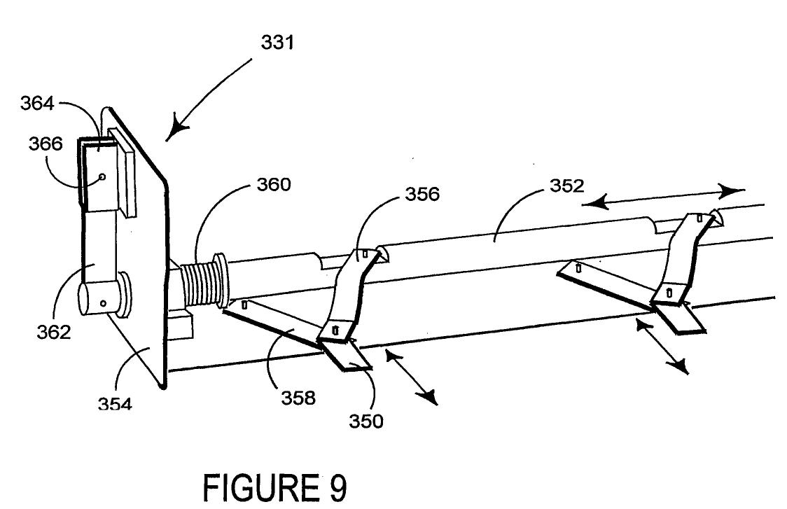

FIG. 9 is a cut-away perspective view showing the mechanism of the invention of FIG. 8.

Referring to FIG. 1, there is shown a platform 10 for use in an airborne extraction system. The platform 10 comprises a base 12 on which the load (e.g. vehicles or supplies) to be extracted is placed. The sides 14 of the base are provided with a portion of the releasable securing means either of the US or UK type that enable the platform to be mounted within a guidance system provided on a payload area of an aircraft. In this embodiment an extraction parachute is secured to the aft edge of the platform using linkage 16.

Referring now to FIGS. 2 and 3 there are shown schematic illustrations of the US type securing system.

This is commonly known as the Brookes and Perkins -4a system (referred to hereinafter as the -4a system). The present invention is concerned primarily with the use of the -4a system for airborne delivery. The particular version illustrated in FIGS. 2 and 3 is fitted to C130 J aircraft used by the UK military. The -4a system may be used for normal cargo handling as well as aerial delivery. The -4a system has variations. The present application describes the technology embodied in UK C130J aircraft but is suitable for use with all known -4a systems. It should be noted that the orientations indicated in the Figures are designated as follows: F=fore, P=port and V=vertical.

The platform illustrated in FIGS. 2 and 3 is generically known as type 5. Type 5 platforms are characterised by a standard 108″ (2.74 m) width, a thin section of typically 2.5″ (68.5 mm) and no energy absorbing capability. Top and bottom skins are generally solid aluminium or GRP sheeting.

Loads attached to the type 5 platform do not have roll on-roll off(“roro”) capability and have to be hardened to withstand landing impact. The -4a system has 2 longitudinal rails provided in the aircraft set just outside 108″ (2.74 m) apart. The rails have a lateral extension 27, which provides vertical restraint of the platform 10. In built into both port and starboard rails are catches 22 which swing in the horizontal plane about pivot 24, into a number of cut-outs 20 provided in side protruding elements 18 of the type 5 platform. This provides lateral, vertical and fore/aft restraint when the catches are deployed.

The port side catches 22 are not sprung loaded and are retracted by the Loadmaster (cargo handler) on the aircraft immediately prior to extraction of the platform 10 as part of the drop procedure. The starboard side catches (not shown) provide permanent forward restraint when deployed and have an adjustable sprung restraint in the aft direction. The springs are adjusted to match the expected extraction force provided by an extractor parachute (not shown) so that inadequate extraction force will not pull the platform 10 out. The starboard side catches can be retracted in order to load the platform 10 onto the aircraft. The -4a system incorporates rollers (not shown) in fore/aft direction at fixed positions. These support the platform 12.

Aerial delivery systems vary but, as discussed above, generally use an extractor parachute released remotely by the pilot. If this generates enough force to overcome the starboard springs, the pallet is extracted. A swinging link (not shown), attached to the platform then is used to disconnect the extractor parachute (not shown) from the rear of the platform. The extractor parachute then pulls out the main descent parachutes (not shown), which allows the platform 10 to descend in a horizontal plane.

The -4a system is prone to mechanical failure; the mechanism of the securement system on the starboard side can fail, causing the catches to be permanently locked, thereby preventing extraction of the platform. The catches of the port side system may become reengaged after they have been retracted by the Loadmaster. If a US type parachute is used the extractor parachute cannot cause enough drag to down the aircraft. Manual means of disconnecting the extractor parachute are used, after the load has been made safe, if a maldrop occurs.

Turning now to FIGS. 4 and 5, these illustrate schematically the UK platform securement system. This is commonly known as Skydel. It is unique to UK aircraft and until the C 130 J aircraft was bought by the UK military has been the sole UK aerial delivery cargo handling system.

The platform types used with the Skydel system do not have a generic name. Acronyms such as MSP (Medium Stressed Platform), HSP (High Stressed Platform), LSP (Low Stressed Platform) and PURIBAD (Platform Rigid Boat Aerial Delivery) are used. These platforms are of various widths up to 100″ (2.540 m) of relatively thick section, typically 200 mm, and have energy absorbing capability for land drops. The bottom has longitudinal surfaces for contact with roller systems and air bags.

Loads attached to the platforms do have “roro” capability and do not have to be hardened to withstand landing impact, which is attenuated by the air bags. The Skydel system has 2 longitudinal rails mounted on the aircraft 126 set at between 88″ (2.235 m) and 100″ (2.540 m) apart. In built into both port and starboard rails are hooks 122, which swing in the vertical plane about horizontal axis 124 to locate against spigots 121 on the platform. This provides vertical and forward restraint. The Skydel system is capable of being expanded to 108″ to receive the Type 5 platform, if required.

Aft restraint is provided by a separate part of Skydel system (not shown), normally a centre mounted release device, which requires a defined parachute load to overcome.

The only action required of a Loadmaster to deliver a load with the Skydel system other than general monitoring is to remove transit chains. The Skydel system incorporates rollers (not shown) in the aft direction at fixed positions which support the platform 112.

Aerial delivery systems vary, but generally use a “reefed mains” parachute (not shown) for extraction. The reefing prevents the parachutes fully opening during extraction. Extraction is activated remotely by the pilot. If the parachutes generate enough drag force to overcome the centreline release requirement, the platform is extracted. A cable (not shown) attached to the aircraft or other suitable mechanism is used to disconnect the reefed mains parachute from the rear of the pallet and brings the parachute into a vertical position which allows the platform to descent in a horizontal plane. Timers release the reefing on the parachutes and allow full deployment.

The system does not suffer from inherent weaknesses. However, the fully deployed mains parachute of the UK system can exert enough force to down the aircraft but the Skydel system does not suffer from the locking malfunction problems of the -4a system, and this has therefore not hitherto been a problem.

A platform according to a first embodiment of the invention has been developed which is usable on all Skydel aerial delivery systems. This embodiment allows for the permanent or temporary conversion from Skydel only compatibility to both -4a and Skydel compatibility. The design of this embodiment retains the desirable platform properties of ruggedness, energy absorption and low level capability. The conversion embodiment extends the width of an 88″ (2.235 m) platform up to 108″ (2.743 m) with the new surface usable for stores.

In an alternative embodiment platforms may be constructed in either 88″ (2.235 m), 100″ (2.540 m) or 108″ (2.743 m) widths with the dual capability. The external extension features are compatible with both the Sykdel and -4a longitudinal beams, with no conversion of the fittings in either aircraft type required. A modified platform 310 is shown in FIG. 6 and in greater detail in FIG. 7. It can be seen that an extension apparatus 330 is secured to the original platform 312 by fitting a plurality of extension beams 334 into transverse beams 332 of the original platform 312 and securing the two together using bolts or other suitable securing means known in the art. In some embodiments, the extension apparatus can be retracted or alternatively removed so as to reduce the width of the beams if required.

The connection may be further reinforced by securing a plate 336 (FIG. 7) of the extension to flange 338. In those embodiments without extension apparatus 330 being in place the plate 336 is used as an anchor point to secure spigot 321 to the platform 310.

In this embodiment, to replicate the functions of the unmodified platform 312, a pair of vertically spaced substantially horizontal flanges 340, 342 extend along the longitudinal length of the extension 330 and enable spigots 321 to be secured at a plurality of positions along the extended platform using bolts or other suitable means that may be secured through apertures provided in the flanges 340, 342 as illustrated.

A further flange 319 extends along the side of the platform 310 substantially adjacent the lower edge thereof. A plurality of cut-outs 320 are provided in the flange for engagement with catches of the -4a system as discussed above.

The platform 310 is therefore provided both with spigots 321 for engagement with the hooks 122 of the Skydel system, as well as cut outs 320to be used with the catches 22 of the -4a system.

The conversion as it stands makes platforms compatible with the US aerial delivery method. However, in order for this platform to be readily interoperable with both systems, the UK type parachute system having a greater extraction force than the US type is advantageously used. If however the UK parachute system is used in conjunction with the -4a securement system and the -4a securement systems jams during extraction, there is a serious risk that the aircraft will be downed due to the increased drag of the parachutes as discussed above. It is therefore desirable that the jamming tendency of the -4a system is mitigated or overcome.

One way of mitigating this jamming tendency is provided by security apparatus of the second embodiment of the invention illustrated in FIGS. 8 and 9. In this embodiment, the -4a locks locating the platform can be prevented from inadvertent deployment by deliberate operation. The apparatus is entirely contained in the platform and thus no modifications need to be made to the aircraft, or -4a system.

The security apparatus comprises means to ensure that the or each of the securement system is moved from a deployed to a retracted position prior to extraction of the platform from the aircraft.

Referring to FIG. 8, the security apparatus is provided by a plugging” mechanism contained within longitudinal side beam 331 of the platform extension 330. As can be seen most clearly from FIG. 9, in this embodiment, the plugging mechanism comprises a rod 352 extending the length of the longitudinal beams and journalled onto end plate 354 at the fore end of the beam 331.

A linkage arm 356 pivotally connects rod 352 to a plug 350 that in its deployed position at least partially fills cut-out 320 as illustrated in FIG. 8. A further arm 358 pivotally connects plug 350 to a fixed position on the beam 331 such that longitudinal movement of rod 352 aft causes the plug 350 to retract and movement fore causes the plug to deploy. Suitable resilient biasing means, for example helical compression spring 360 fitted around rod 352 adjacent end plate 354 biases the rod 352 aft such that plugs 350 are normally retracted. It should be understood that in other embodiments alternative mechanism, such as cam and follower arrangements, may be used to retract and deploy the plugs 350.

To retain the plugs in a deployed position when necessary, locking means is provided to lock the rod in a deployed position. In this embodiment, the locking means comprises a locking bar 362 fitted to the fore end of the rod 352. The bar 362 is pivotally secured to rod 352 using a pin or other suitable means. In order to lock the bar, it is brought into an upright position as shown in FIG. 9 and secured to flange 362 using a locking pin (not shown) through aperture 366. It is envisaged that in other embodiments, alternative locking mechanisms known in the art may be used, such as a T bar (not shown) linked to rod 352 and arranged to protrude through the upper surface of beam 331. The T bar is locked in open and closed positions by a hinged cover box.

It can be seen that this movable plug arrangement enables all of the cut-outs on one side of the platform to be remotely plugged by the aircraft Loadmaster or other personnel.

This apparatus embodiment of the invention is compatible with and improves the reliability of the -4a system when used with the US parachute system. The catches on the starboard side of the aircraft must remain functional to provide restraint against parachutes and the apparatus need only be fitted to port side of the platform. If the plugging apparatus is used with the UK-type parachute system on port and starboard sides, then extraction safety is improved.

In a third embodiment of the present invention, the safety means comprises apparatus for providing a visual indication that all of the relevant catches have been successfully retracted. It is normally not easy for the aircraft Loadmaster to make a visual inspection of the catches because these are effectively hidden due to the deeper platforms used with the Skydel system. However, even with the thinner US Type 5 platform a visual inspection of possible engagement cannot always be relied on. Again, in this embodiment, the apparatus for providing the visual indication is entirely contained within the platform and therefore modification at the aircraft is not required.

This embodiment essentially operates as a reverse of the plugging mechanism of the previous embodiment. Rather than plugs 350 acting to prevent deployment of catches, a deployed catch causes plug 350 to retract and rod 352 to slide aft. The position of rod 352 relative end plate 354 thus provides a visual indication of the position of the locks. The visibility of the system may be improved by including a suitable indicator mechanism that is attached to rod 352. One type of indicator system is provided by a sensor to detect the position of the rod 352 and/or the plugs 350. Once in a deployed position, the sensor will emit a signal to a display unit, for example an LED. Of course, other known indicator systems can be employed without departing from the scope of invention.

In order that this embodiment operates satisfactorily, the resilient biasing means, for example the helical spring 360, is arranged so as to bias rod 352 fore, normally causing plugs 350 to be deployed. Of course, locking bar 362 and flange 364 are not required for the mechanism of this embodiment to function.

The apparatus of this embodiment is compatible with current US operations but is only fitted to port side of the platform. The apparatus improves the safety of extraction when using the -4a system with UK type parachutes.

In a fourth embodiment (not shown) the -4a catches locating the platforn can be prevented from inadvertent function by not having the cut outs 320 in the side rails thus providing a smooth uninterrupted flange with which catches 22 will not engage.

For the platform of this embodiment to function with the -4a system, alternative means of forward restraint is provided, aft restraint preferably being provided by the aircraft centreline release system. In a preferred embodiment, forward restraint is provided by a stop (not shown) that may be raised from the floor of the guidance system when required, but which may be retracted when not in use. To enable platforms to be secured in a variety of positions along the length of the aircraft payload area a plurality of such stops may be provided. If the conversion of the first embodiment and is used with the fourth embodiment of the present invention and is operated with the UK type parachute system, then the safety of the drop operation is significantly improved.

In a fifth embodiment, locking mechanism on aircraft fitted with the -4a system is modified such that all -4a catches (not just the starboard catches) aft of the platform can be prevented from inadvertent deployment by pinning in a retracted position. The apparatus of this embodiment functions independently of the platform. The modification is preferably achieved by fitting a locking pin (not shown) to the catch mechanism. This apparatus is compatible with current US parachute systems but need only be fitted to port side because the starboard locks may be pinned out under the standard -4a system. The modifications of this embodiment improve the safety and reliability of the drops using the US parachute system.

The fifth embodiment of the invention may be combined with either the second or fourth embodiments to provide optimum safety when UK type parachute systems are used with the -4a type securement system. When the fifth embodiment of the invention is combined with the plugging apparatus of the second embodiment, the platform 310 is loaded in the aircraft, port and starboard catches aft of the platform are secured in a retracted position using the locking pins. When platform release is required, the remaining port catches are retracted and the plugs 350 are deployed by the loadmaster to fill cut-outs 320. The parachute can then be deployed and extraction of the platform executed safely.

It should be understood that the terms “fore”, “aft”, “port”, “starboard” and “vertical” are used for convenience, and the embodiments of the invention described above are not limited to these particular orientations. It should further be understood that numerous changes may be made within the scope of the invention. For example, other known plugging and pinning mechanisms may be employed.

1. Safety apparatus for a cargo platform for releasable securement in an aircraft fitted with a complementary type securement system having one or more retractable catches for engaging the cargo platform, wherein the safety apparatus comprises means to ensure the or each catch of the securement system is moved from a deployed to a retracted position prior to extraction of the platform from the aircraft:

2. Apparatus according to claim 1 further comprising a visual indicator to indicate the deployed/retracted state of the securement system.

3. Apparatus according to claim 2 wherein the visual indicator is provided at the fore end of the apparatus.

4. Apparatus according to claim 2 or claim 3 wherein a recess on the platform for engaging the catch is provided with a movable plug connected by a linkage to the visual indicator wherein the plug is depressed inwardly by the presence of the catch in the recess.

5. Apparatus according to any of claims 1 to 3 wherein a recess on the platform for receiving the catch is provided with a moveable plug connected to the platform and moveable from a retracted position to a deployed position in which the plug protrudes into the recess to prevent the catch of the securement system from engaging in the recess.

6. Apparatus according to claim 5 wherein a linkage connects the plug to locking means for locking the plug into a deployed position so as to prevent engagement of the catch by the recess.

7. Apparatus according to claim 6 wherein a plurality of plugs are provided and the locking means is so constructed and arranged to simultaneously prevent deployment of a plurality of catches.

8. Apparatus according to any preceding claim wherein there further comprises safety means including a mechanism to ensure that a second catch of the securement system, aft of the platform, is retracted to allow the platform to be released.

9. Apparatus according to claim 8 wherein the mechanism comprises a locking pin fitted to the second catch.

10. Apparatus according to claim 1 wherein the securement system has catches arranged so as to normally engage in corresponding recesses and wherein the recesses are omitted thereby preventing such engagement, the platform being provided with other means for releasable securement.

11. Apparatus according to claim 10 wherein the other means comprises a stop that may be deployed to engage the platform.

12. Apparatus according to claim 11 wherein the stop engages the fore or aft end of the platform.

13. A cargo platform comprising safety apparatus according to any preceding claim.

14. A cargo platform capable of releasable securement to aircraft having both the -4a or Skydel securement systems.

15. A platform according to claim 14 having an outer support with one or more recesses for securement by the -4a system and one or more spigots for securement by the Skydel system.

16. A platform according to claim 15 wherein the platform is converted from a Skydel only type platform by securing a longitudinal extension piece thereto incorporating the outer support having one or more recesses and one or more spigots.

17. A method of releasing a platform, the platform being releasably secured on a guidance system in an aircraft using an interference type securement system comprising a catch and a recess, formed in the platform to receive the catch, the method comprising the steps of:
i) retracting the catch; and
ii) employing safety apparatus as claimed in any of claims 1 to 12 to ensure that the catch is retracted.

18. A method according to claim 17 wherein the safety apparatus indicates the deployed/retracted state of the catch to a user.

19. A method according to claims 17 to 18 wherein a second catch is provided aft of the platform and there comprises a further step of preventing the inadvertent deployment of the second catch.

20. A method according to claim 19 wherein the inadvertent deployment of the second catch is prevented by pinning the second catch in a retracted position.
